(19) United States
(12) Patent Application Publication
(10) Pub. No.: US 2015/0045009 A1
(43) Pub. Date: Feb. 12, 2015

(54) Mobile Telephone and Method for Declining an Incoming Call

(71) Applicants: Franciscus Auguste Maria GOIJARTS, (US); Frans Willem Auguste Maria GOIJARTS, (US)

(72) Inventors: Franciscus Auguste Maria Goijarts, Hilversum (NL); Frans Willem Auguste Maria Goijarts, Hilversum (NL)

(21) Appl. No.: 14/386,983

(22) PCT Filed: Mar. 22, 2013
(86) PCT No.: PCT/NL2013/050209

§ 371 Date: Sep. 22, 2014

(30) Foreign Application Priority Data
Mar. 22, 2012 (NL) 2008519

(51) Int. Cl. H04M 1/725; H04W 68/00

(52) U.S. Cl. CPC H04M 1/72577; H04M 1/72563; H04W 68/005; H04W 88/06
USPC 455/418; 455/566

(57) ABSTRACT

The present invention relates to a mobile telephone comprising a housing and a touch screen, wherein the mobile telephone is switchable into a locked mode in which the touch screen is not responsive to an user input unless a predetermined operation is performed, wherein the mobile telephone is configured to receive an incoming call when the mobile telephone is in the locked mode and accept the incoming call after a predetermined user acceptance input, characterized in that the mobile telephone is also configured to decline the incoming call after a predetermined user decline input on the touch screen and/or housing while the mobile telephone remains in the locked mode.

The present invention relates to a mobile telephone comprising a housing and a touch screen. According to another aspect, the present invention relates to a method for declining an incoming call on a mobile telephone comprising a housing and a touch screen.

Mobile telephones, also known as mobile phones, cell phones, cellular telephones, cell phone and the like, become more compact and the numbers of functions performed by a mobile telephones increase. For example, the use of vibrate means on mobile telephones is already established whereas the use of a touch screen on a mobile phone is a more recent development.

Touch screens, also known as touch sensitive displays, form a user interface that allows users to easily interact with the various functions of the mobile telephone. For example, the use of touch screens eliminates the problem of adding more pushbuttons, overloading the pushbuttons with several functions or using complex menu systems.

A user is usually notified on an incoming call by use of a ringtone mode which provide a sound signal or by use of a vibrate mode which provides vibrations to the mobile telephone.

A vibrate mode on a mobile telephone, commonly provided by vibrate means, serves a practical goal: notifying the user on an incoming event such as an incoming call without using a ringtone. As a result of this function, mobile telephones can remain in an ‘switched on mode’ when the user is advised to avoid making noise. For example in a meeting room, school class, museum, library, cinema and the like. Normally, a vibrate mode is set by the user in the menu of the mobile phone or by switching a switch.

However, besides the practical use, there are some drawbacks hindering the use of the vibrate mode. For example if the vibrate mode is insufficiently quiet or the mobile telephone is laying on a hard surface, vibrating the mobile telephone may create an annoying noise. This annoying noise may irritate the user and bystanders. An example is the scenario where, during a meeting, everyone's attention is fixed at the noise of a vibrating mobile telephone. Accordingly, the user may have to turn off the mobile telephone or set the mobile telephone to a silent mode. However, than the user is not longer notified on incoming events, and may miss for example an important incoming call.

When the mobile telephone is in the ringtone mode, the sound signal may be disturbing, and with conventional mobile telephones declining the incoming call and switching off the sound signal takes too long. Thus, the manner for declining the incoming call is not efficient.

Therefore, there is a need in the art for a mobile telephone that can notify the user on an incoming call, without having the above mentioned disadvantages of disturbing bystanders.

It is therefore an object of the present invention, amongst other objects, to provide a solution to the above mentioned problems. This object, amongst other objects, is met by providing a mobile telephone according to the appended claim 1.

More specifically, this object, amongst other objects, is met by providing a mobile telephone comprising a housing and a touch screen, wherein the mobile telephone is switchable into a locked mode in which the touch screen is not responsive to an user input unless a predetermined operation is performed, wherein the mobile telephone is configured to receive an incoming call when the mobile telephone is in the locked mode and accept the incoming call after a predetermined user acceptance input, characterized in that the mobile telephone is also configured to decline the incoming call after a predetermined user decline input on the touch screen and/or housing while the mobile telephone remains in the locked mode.

The term ‘mobile telephone’ is used within the present context as a device which can make and receive phone calls whilst moving around a geographic area. Mobile telephones which also provide several other computing capabilities are commonly referred to as smartphones.

The term ‘housing’ as used in the present context means the body of the mobile telephone, which encompasses the back and front sides as well as the edges of the mobile telephone.

The term ‘touch screen’ or ‘touch sensitive display’ as used within the present context means a display able to detect user inputs, such as a gesture, finger gesture, tap or finger tap on the touch screen and translate these detected user input into commands to be performed.

The term ‘incoming call’ as used in the present context means the stage wherein the present mobile telephone receives an incoming call and signals this incoming call to the user by for example a ringtone and/or vibrating means, but wherein the connection between the caller and the called one is not established yet. With regard to the present invention, the incoming call may receive the present mobile telephone via a mobile telephone network and/or via wireless mobile internet services such as a 3G mobile network (for example via a UMTS system) or local WIFI network. Preferably although, the present incoming call is received via a mobile telephone network such as Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), and/or Integrated Digital Enhanced Network (iDEN).

The term ‘locked mode’ as used in the present context means a mode wherein the touch screen is not activated and not able to detect a user's input, unless a predetermined operation is performed. However, when the mobile telephone receives an incoming call, the touch screen is activated and able to receive user's input, although the mobile telephone was at time of receiving the incoming call switched into the locked mode.

‘Predetermined operation’ as used in the present context means an operation which is detectable by mobile telephone, for example via the touch screen and/or housing, although the present mobile telephone is switched in the locked mode. Examples of predetermined operations are a predetermined user acceptance input and a user decline input. A predetermined user acceptance input is the input to accept the incoming call. A predetermined user decline input is the input to decline the incoming call. The present mobile telephone may detect the user acceptance input via the touch screen, but also via for example a keyboard such as QWERTY keyboard, if the present mobile telephone comprises a touch screen and a keyboard. The predetermined user decline input may be on the touch screen as well as on the housing, or body, of the mobile telephone. The predetermined user decline input can be detected via an accelerometer, gyroscope and/or via the touch screen. The accelerometer and gyroscope may detect movement of the predetermined user decline input on the housing and/or touch screen of the mobile telephone. The touch screen may detect the predetermined user decline input on the touch screen. Preferably, the present user decline input is detected via the touch screen, preferably without using an accelerometer and/or gyroscope.

‘Remaining in the locked mode’ as used in the present context means that the present mobile telephone remains switched into the locked mode after declining an incoming call.

The mobile telephone provided by the present invention solves the above mentioned technical problem. Specifically, the present mobile telephone provides a very efficient way for switching off the sound generating modes such as ringtone mode or vibration mode, since only a user decline input on the touch screen and/or housing is enough to decline the incoming call and, preferably, to switch these sound generating modes off.

The mobile telephone according to the present invention even allows stop ringing or vibrating the mobile telephone by touching the present touch screen and/or housing through the trousers when the mobile telephone is stored in a user's pocket. Thus, by using the present mobile telephone, the user is able to get notified on the incoming call by for example vibration, however, the user is able to reduce the disturbing noise of the vibrating mobile telephone immediately.

According to a preferred embodiment, the present mobile telephone is characterized in that the mobile telephone is configured to switch off a ringtone or a vibration mode of the mobile telephone after the predetermined user decline input on the touch screen and/or housing.

The term ‘ringtone means’ as used within the present context are means for generating a ringtone, such as a speaker.

The term ‘vibrate means’ as used within the present context are means able to vibrate the mobile telephone on a level sufficient to be notified by the user of the mobile telephone. Particularly, the vibrate means are able to vibrate the mobile telephone on a level sufficient to be notified by the user of the mobile telephone when the mobile telephone is stored in the user's pocket.

The present mobile telephone advantageously provides to keep the vibrate mode switched on in, for example, a meeting, and get notified on an incoming call, however the vibrations can be stopped easily by the user for example by touching the touch screen. Thus, the user has the advantage of the vibrate mode, i.e. he will get notified on an incoming call, however a disturbing noise resulting from the vibrating mobile telephone can be limited to a minimum.

In a preferred embodiment, the present mobile telephone is characterized in that the predetermined user decline input on the touch screen and/or housing is at least two taps, or two or more taps. After detecting tapping, gently slapping or gently knocking on the touch screen and/or housing the present mobile telephone is able to decline the incoming call. Two taps are advantageous since this is a clearly different signal than one erroneous tap. Therefore, one erroneous tap will preferably not decline the incoming call. Further, the present mobile telephone is able to detect the two taps when they are given via textile, for example textile of a pocket where the mobile telephone is stored in. Preferably, the present user decline input on the touch screen and/or housing is at least three, four or five taps. Preferably, the present user decline input on the touch screen and/or housing is one long tap, or finger contact, preferably of at least half a second, one second or about one second, or at least about one and a half second or two seconds.

According to yet another preferred embodiment, the present mobile telephone is characterized in that the mobile telephone is configured to detect the present user decline input on each area, or each surface, of the touch screen and/or housing. This is advantageous since it provides declining the incoming call via an easy to perform, not specifically targeted, user input. This advantageously enables the user to decline an incoming call without looking at the mobile telephone, for example when the mobile telephone is stored in the pocket of a pair of trousers or shorts. Further, the user may decline an incoming call by performing the user decline input on the back of the mobile telephone. This is advantageous since an incoming call can be declined immediately, irrespective of the position of the mobile telephone stored in a pocket, bag or suitcase. Accordingly, the present mobile telephone preferably comprises an accelerometer and a processor to operate the operations of the mobile telephone.

According to a preferred embodiment, the present mobile telephone is characterized in that the predetermined user acceptance input is a on the touch screen.

According to yet another preferred embodiment, the present mobile telephone is characterized in that the predetermined user acceptance input is a swipe gesture. Preferably the present mobile telephone can detect the swipe gesture in a predetermined area of the touch screen.

According to yet another preferred embodiment, the present mobile telephone is characterized in that the mobile telephone is configured to detect the predetermined user acceptance input on the touch screen and the predetermined user decline input on the same area of the touch screen. This is advantageous since it allows the user to efficiently decline the incoming call without precisely targeting its user decline input.

Given the advantageous properties of the present mobile telephone for declining an incoming call, the present invention relates according to a further aspect to a method for declining an incoming call on a mobile telephone comprising a housing and a touch screen wherein the mobile telephone is switchable into a locked mode in which the touch screen is not responsive to an user input unless a predetermined operation is performed, which method comprises the steps:
(i) receiving an incoming call when the mobile telephone is in the locked mode
(ii) declining the incoming call after a predetermined user decline input on the touch screen and/or housing while the mobile telephone remains in the locked mode.

According to a preferred embodiment, the present method further comprises:
(iii) switching off a ringtone or a vibration mode of the mobile telephone while declining the incoming call.

Advantageously, the present method allows a user to very efficiently decline an incoming call, therewith minimizing noise provided by the ringing or vibrating mobile telephone.

According to yet another preferred embodiment, the present method is characterized in that the predetermined user decline input on the touch screen and/or housing is at least two taps.

The present invention is further elucidated in the following description with reference to the accompanying schematic figures. In the figures non limitative embodiments of the device and the method according to the invention are shown.

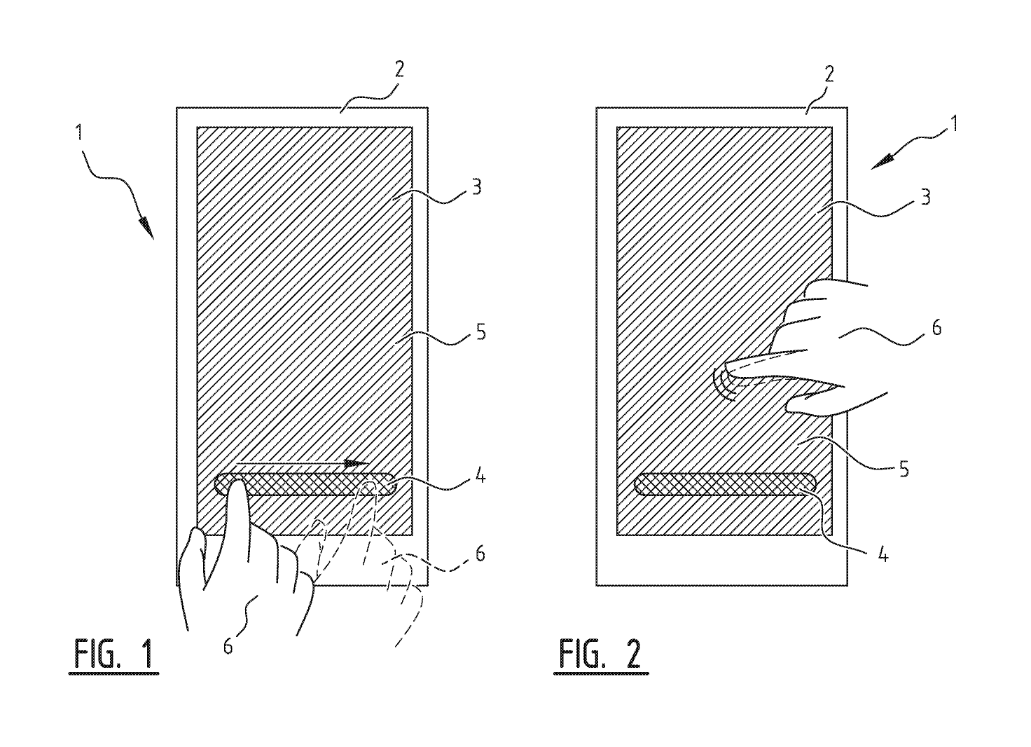

FIG. 1 shows in front view a mobile telephone according to the invention on which an user acceptance input is visualized;

FIG. 2 shows in front view a mobile telephone according to the invention on which a user decline input is visualized.

The mobile telephone 1 as shown in FIG. 1 has a housing 2 and a touch screen 3. Further, the touch screen 3 defines an area 4 and an area 5 and a user's hand 6.

As is shown in FIG. 1, the present user acceptance input is in this figure the swipe gesture from the user from left to right in the predetermined area 4. By performing the user acceptance input the incoming call is accepted and connection established.

FIG. 2 shows the mobile telephone 1 with a housing 2 and a touch screen 3. Further, the touch screen 3 defines an area 4 and an area 5 and a user's hand 6.

As shown in FIG. 2, the user's hand 6 performs a user decline input which is here a tap on the touch screen in the defined area 5. The defined area 5 is here the complete touch screen, also contemplating the defined area 4 which is able to detect the user decline tap. Therefore, the user decline tap, or input, can be given on the whole touch screen 3. By performing the user decline tap, the incoming call is declined and the ringtone or vibration mode is stopped. The user decline input tap, or input, is detected via the touch screen 3. However, the user input tap may also be detected via an accelerometer detecting movement of the mobile telephone 1 resulting from the user input tap.

The description and drawings merely illustrate the principles of the invention. It will thus be appreciated that those skilled in the art will be able to devise various arrangements that, although not explicitly described or shown herein, embody the principles of the invention and are included within its spirit and scope.

Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. Mobile telephone comprising a housing and a touch screen, wherein the mobile telephone is switchable into a locked mode in which the touch screen is not responsive to an user input unless a predetermined operation is performed, wherein the mobile telephone is configured to receive an incoming call when the mobile telephone is in the locked mode and accept the incoming call after a predetermined user acceptance input, characterized in that the mobile telephone is also configured to decline the incoming call after a predetermined user decline input on the touch screen and/or the housing while the mobile telephone remains in the locked mode.

2. Mobile telephone according to claim 1, comprising ringtone and/or vibrations means characterized in that the mobile telephone is configured to switch off a ringtone and/or a vibration mode of the mobile telephone after the predetermined user decline input on the touch screen and/or housing.

3. Mobile telephone according to claim 1, characterized in that the predetermined user decline input on the touch screen and/or housing is at least two taps.

4. Mobile telephone according to claim 1, characterized in that the mobile telephone is configured to detect the user decline input on each area of the touch screen and/or housing.

5. Mobile telephone according to claim 1, characterized in that the predetermined user acceptance input is a on the touch screen.

6. Mobile telephone according to claim 5, characterized in that the predetermined user acceptance input is a swipe gesture.

7. Mobile telephone according to claim 5, characterized in that the mobile telephone is configured to detect the predetermined user acceptance input on the touch screen and the predetermined user decline input on the same area of the touch screen.

8. Method for declining an incoming call on a mobile telephone comprising a housing and a touch screen wherein the mobile telephone is switchable into a locked mode in which the touch screen is not responsive to an user input unless a predetermined operation is performed, which method comprises the steps:
(i) receiving an incoming call when the mobile telephone is in the locked mode;
(ii) declining the incoming call after a predetermined user decline input on the touch screen and/or housing while the mobile telephone remains in the locked mode.

9. Method according to claim 8, further comprising:
(iii) switching off a ringtone or a vibration mode of the mobile telephone while declining the incoming call.

10. Method according to claim 8, characterized in that the predetermined user decline input on the touch screen and/or the housing is at least two taps.
